(19) United States
(12) Patent Application Publication
(10) Pub. No.: US 2002/0093165 A1
(43) Pub. Date: Jul. 18, 2002

(54) Human powered skateboard roller coaster

(76) Inventor: Dan Greene, Evergreen, CO (US)

Correspondence Address: EDWIN H. CRABTREE, Suite 575, 3773 CHERRY CREEK N. DR., DENVER, CO, 80209, US

(21) Appl. No.: 09/765,154

(22) Filed: Jan. 17, 2001

(51) Int. Cl. B62M 1/00

(52) U.S. Cl. 280/87.041; 280/11.19

(57) ABSTRACT

A human powered skateboard roller coaster used by skateboarders having various degrees of skateboarding skills. The skateboard roller coaster broadly includes a skateboard having wheels attached to a first and second rail of a roller coaster like track. The roller coaster like track can have various curved and up and down track configurations. The skateboard includes a foot platform with a removable upwardly extending adjustable hand grip support with a hand grip attached to the top of the support. The hand grip provides a convenient safety grip for helping balance during practice. The foot platform includes a first end portion with first pivot bolt and a second end portion with second pivot bolt. The first and second pivot bolts are attached to wheel pivot blocks mounted under the end portions of the foot platform. The pivot blocks include wheel bearing supports. A plurality of upper and lower first wheels and upper and lower second wheels are rotatably mounted on the wheel bearing supports. The upper and lower wheels engage a portion of the top and bottom of the first and second rails for holding the skateboard thereon as the skateboarder navigates around the curved up and down roller coaster like track.

### BACKGROUND OF THE INVENTION

(a) Field of the Invention

This invention relates to practicing on a skateboard and more particularly, but not by way of limitation, to a skateboard attached to one or more rails of a roller coaster like track for providing a skateboard roller coaster for training skateboarders with various skill levels.

(b) Discussion of Prior Art

With the popularity of skateboarding and snowboarding, more and more people of various ages are learning to skateboard. During the learning process, balance and dexterity are required to become skilled in skateboarding. When learning to skateboard, public sidewalks and streets are used for practice along with empty swimming pools or drainage tunnels. Practicing at these type of locations presents a safety hazard to both the skateboarder and the public. Recently, skateparks, which include half pipes, quarter pipes and ramps have been built by communities for the enjoyment of skateboarders. But, because of the cost of a skatepark, the number is limited in the United States.

In U.S. Pat. No. 4,121,821 to Graham, a skateboard rink is disclosed. The rink is formed with spaced mounds of earth for providing a skateboarder with a circuitous and undulating riding track. In U.S. Pat. No. 4,172,593 to Palakanis, another skateboard rink is illustrated and in the form of a figure. 8-shaped track. The track includes banked end sections and ramped intermediate sections. In U.S. Pat. No. 4,693,183 to Potzsch, a track system for a roller coaster is described.

None of the above mentioned patents disclose the unique features, structure, objects, advantages and function of the subject human powered skateboard roller coaster for training skateboarders as described herein.

### SUMMARY OF THE INVENTION

In view of the foregoing, it is a primary object of the subject invention to provide a human powered skateboard roller coaster. The skateboard roller coaster can be used by skate boarders having various degrees of skateboarding skills.

Another object of the invention is the skateboard roller coaster allows a beginning skateboarder to practice balance and speed more easily and without having to continually fall off of a skateboard when developing new skills.

Yet another object of the skateboard roller coaster is to allow a more advanced skateboarder to practice with increased speed and agility around curves, up hills and down valleys.

Still another object of the invention is the roller coaster can include tracks with various curved up and down configurations, with different degrees of difficulty and built at various levels of expense.

The skateboard roller coaster broadly includes a skateboard having wheels attached to one or more rails of a roller coaster-like track. The roller coaster-like track can have various curved and up and on track configurations with different degrees of difficulty.

The skateboard includes a foot platform with a removable upwardly extending adjustable hand grip support with a hand grip attached to the top of the support. The hand grip provides a convenient safety grip for helping the skateboarder maintain balance and stay on the skateboard during practice. The hand grip can be quickly removed when no longer required or of interest by the skateboarder.

The foot platform includes a first end portion with first pivot bolt and a second end portion with second end pivot bolt. The first and second pivot bolts are attached to wheel pivot blocks mounted under the end portions of the foot platform. The pivot blocks include first and second wheel supports. A plurality of upper and lower first wheels with wheel bearings and upper and lower second wheels with wheel bearings are rotatably mounted on the wheel supports. The upper and lower wheels engage a portion of the top and bottom of the first and second rails for holding the skateboard thereon as the skateboarder navigates around the curved and up and down roller coaster like track

These and other objects of the present invention will become apparent to those familiar with skateboards and how skateboarders develop skateboard skills on side walks, recreation areas and skateboard parks when reviewing the following detailed description, showing novel construction, combination, and elements as herein described, and more particularly defined by the claims, it being understood that changes in the embodiments to the herein disclosed invention are meant to be included as coming within the scope of the claims, except insofar as they may be precluded by the prior art.

### BRIEF DESCRIPTION OF THE DRAWINGS

The accompanying drawings illustrate accompanying drawings complete preferred embodiments in the present invention according to the best modes presently devised for the practical application of the principles thereof, and in which:

FIG. 1 is a perspective view of the subject skateboard roller coaster with a skateboarder practicing on a skateboard having a plurality of wheels. The wheels rotatably attached to first and second rails of a roller coaster track. The track having a curved and up and down configuration. The skateboarder is shown heading uphill on the track.

FIG. 2 is an end view of the roller coaster track with the skateboarder balanced on the skateboard and heading downhill on the track.

FIG. 3 is a top view of the roller coaster track. The track having an oval shaped configuration. The track includes a track stand with an upright track safety rail.

FIG. 4 is a front view of the roller coaster track and skateboarder on the skateboard as shown in FIG. 2.

FIG. 5 is a front view of the skateboard with a removable and adjustable hand grip support attached to an inside of the skateboard. A hand grip is mounted on top of the hand grip support. The hand grip is used for helping the skateboarder maintain balance on the roller coaster like track.

FIG. 6 is an enlarged perspective view of a wheel pivot block with a pair of wheel supports. The wheel supports having upper and lower wheels with wheel bearings for engaging a portion of the top and bottom of first and second track rails. The wheel pivot block is mounted under either a first end portion or a second end portion of a foot platform of the skateboard.

FIG. 7 is an end view of the skateboard and a cross section of the first and second rails of the roller coaster like track taken along lines 7-7 shown in FIG. 5.

FIG. 8 is a side view of a portion of the foot platform and one of the wheel supports with upper and lower wheels taken along lines 8-8 shown in FIG. 6.

### DESCRIPTION OF THE PREFERRED EMBODIMENTS

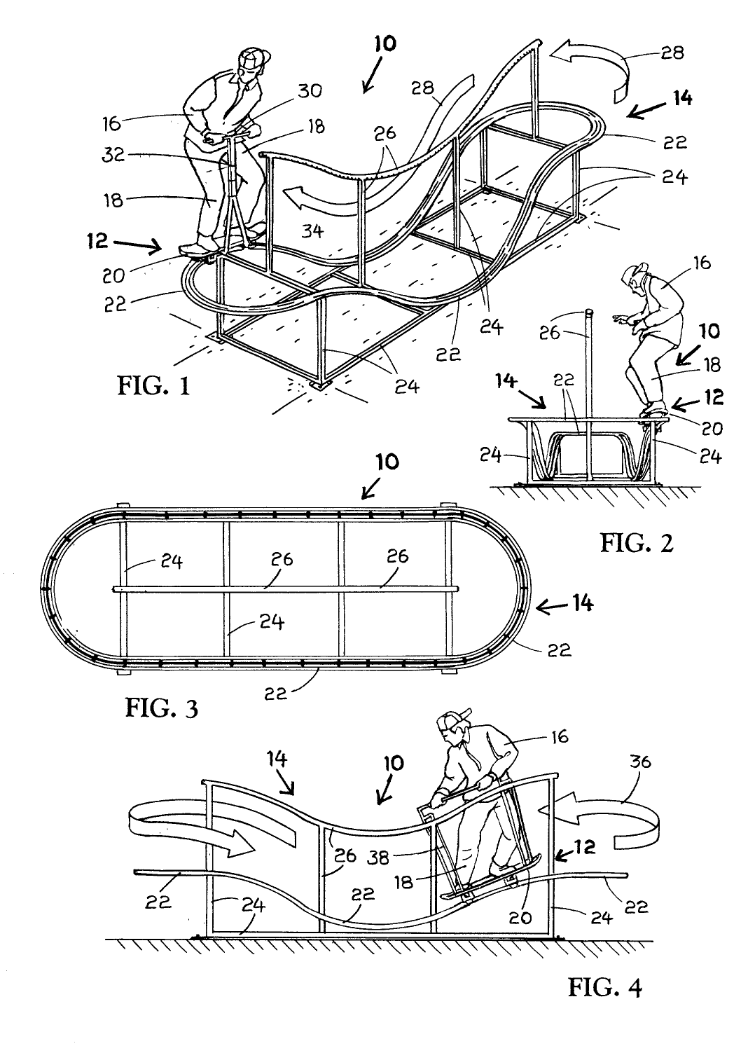

In FIG. 1, a perspective view of subject the human powered skateboard roller coaster is illustrated and having general reference numeral 10. The skateboard roller coaster 10 broadly includes a skateboard, having general reference numeral 12 and a roller coaster having general reference numeral 14. A skateboarder 16 is shown with his feet 18 balanced on a foot platform 20. the foot platform 20 is part of the skateboard 12.

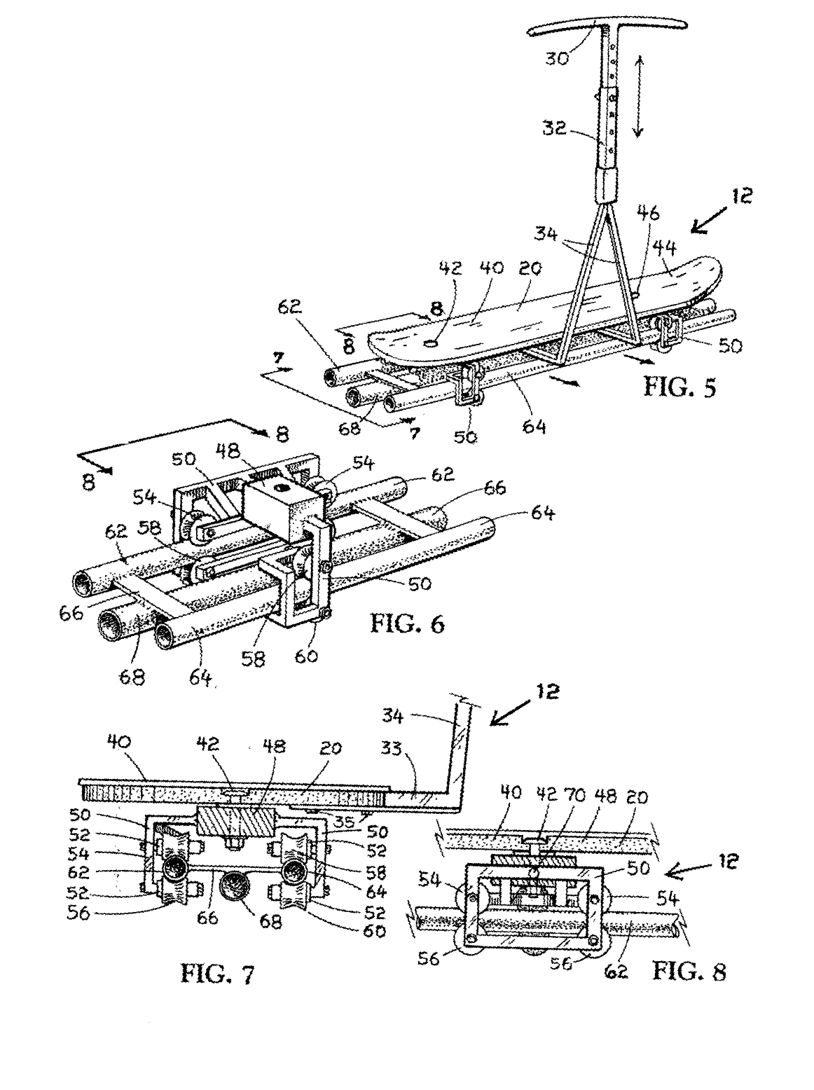

The roller coaster 14 broadly includes a roller coaster like track 22. The track may include a monorail, a pair of rails as shown in FIGS. 5-7, or various configurations of rails for engaging the wheels of the skateboard 12. The track 22 includes track frame supports 24 for creating hills, valleys and curved configurations of the roller coaster 14. Also, the track 22 includes an upwardly extending track safety rail 26 for gripping by the skateboarder 16 should he or she lose balance when negotiating the track 22 on the skateboard 20.

In this drawing, the skateboarder 16 is shown heading uphill, as indicated by arrow 28, on the track 22. Also shown in this drawing is the skateboarder holding on, for balance, to a hand grip 30. The hand grip 30 is attached to the top of a removable and adjustable hand grip support 32 with support arms 34 attached to the inside of the skateboard 20.

In FIG. 2, an end view of the roller coaster track 22 is illustrated. In this view, the skateboarder 16 is shown balanced on the skateboard 20 and heading downhill on the track 22. In this example, the adjustable hand grip support 32 and hand grip 30 have been removed from the skateboard 20. Obviously, as the skateboarder16 advances in skill and agility, he or she may or may not wish to have the hand grip support 32 and hand grip 30 mounted on the skateboard 20.

In FIG. 3, a top view of the roller coaster track 22 is illustrated. The track 22, in this example, has an oval shaped configuration. As mentioned above, the track 22 can have various shapes, curves and configurations with different degrees of difficulty for beginning and advanced skateboarders.

In FIG. 4, a front view of the roller coaster track 22 is shown with the skateboarder 16 heading downhill as indicated by arrow 36. In this illustration, a frame type hand grip 38 is attached to the skateboard 20. Obviously, different types and designs of hand grips and supports can be attached to the skateboard 20 and to the track frame supports 24 without departing from the spirit and scope of the invention.

In FIG. 5, a perspective view of the skateboard 20 is shown with the removable and adjustable hand grip support 32 and support arms 34 attached to a side of the skateboard 20. The hand grip 30 is mounted on top of the hand grip support 32.

In FIG. 6, an enlarged perspective view of one of the wheel pivot blocks 48 is shown with a pair of wheel supports 50 extending outwardly and downwardly from the sides of the block 48. The wheel supports 50 are attached to wheel bearings 48. The wheel bearings 48 are shown in FIG. 7. Mounted on the wheel bearings 52 are a plurality of upper and lower first wheels 54 and 56 and a plurality of upper and lower second wheels 58 and 60. The upper and lower first wheels 54 and 56 are shown in this drawing engaging a portion of the top and bottom of a first rail 62. The upper and lower second wheels 58 and 60 are shown in this drawing engaging a portion of the top and the bottom of a second rail 64. The first and second rails 62 and 64 are shown attached to cross members 66, which are secured to a track support rail 68. This combination of structure forms the track 22.

It should be noted that the engagement of the upper and lower wheels on the first and second rails provide for holding the skateboard 20 on the track 22 as the skateboarder 16 navigates around the curved and up and down roller coaster like track. While the upper and lower wheels are shown in the drawings, it can be appreciated that wheels mounted on the skateboard and engaging opposite sides of the rails will work equally well in guiding the skateboard 12 on the track 22. While the upper wheels 54 and 58 and lower wheels 56 and 60 are shown in the drawings, the skateboard 16 can have only upper wheels 54 and 58 for engaging the track 22 and without the use of the lower wheels 56 and 60.

In FIG. 7, an end view of the skateboard 16 is shown with a cross section of the first and second rails 62 and 64 of the roller coaster like track 22 taken along lines 7-7 shown in FIG. 5. In this view, the upper and lower first wheels 54 and 56 and the upper and lower second wheels 58 and 60 are shown with a concave configuration for engaging the top and bottom of the first and second rails 62 and 64. While the concave configuration of the wheels is shown, it should be kept in mind that a flat wheel configuration can be used equally well. Further, the wheels can have a spool shaped design which allows the wheel greater freedom of lateral movement on the rails 62 and 64 when traversing the track 22.

Also as mentioned above, while use of a pair of rails 62 and 64 are shown in the drawings, a monorail can be used along with other types of rail configurations for engaging the surface of the wheels of the skateboard 16 and holding the skateboard on the track 22 and without departing from the spirit and scope of the invention.

In FIG. 8, a side view of a portion of the foot platform 20 and one of the wheel bearing supports 50 is shown. In this drawing the first upper and lower wheels 54 and 56 are illustrated taken along lines 8-8 shown in FIGS. 5 and 6. It should be noted that the wheel bearing supports 50 are pivotally attached to the opposite sides of the wheel pivot block 48 using pivot pins 70. The pivot connection of the wheel bearing supports 50 on the pivot block 48 allow for the wheel bearing supports 50 to move up and down vertically as the wheels move along the length of the track 22. Also, the first and second pivot bolts 42 and 46 allow the wheel pivot blocks 48 to rotate laterally as the skateboard 12 moves around the curves of the track 22.

While the invention has been particularly shown, described and illustrated in detail with reference to the preferred embodiments and modifications thereof, it should be understood by those skilled in the art that equivalent changes in form and detail may be made therein without departing from the true spirit and scope of the invention as claimed except as precluded by the prior art.

The embodiments of the invention for which as exclusive privilege and property right is claimed are defined as follows:

1. A human powered skateboard roller coaster used by skateboarders having various degrees of skateboarding skills, the skateboard roller coaster comprising:
a skateboard having a foot platform, said foot platform having a first and second end portion;
a plurality of wheels mounted under the first and second end portion of said foot platform; and
at least one rail forming a roller coaster like track, said roller coaster like track having various curved up and down track configurations, said wheels rotatably mounted on said rail.

2. The skateboard roller coaster as described in claim 1 wherein said wheels are mounted on wheel bearings attached to wheel bearing supports, said wheel bearing supports pivotally attached under the first and second end portions of said foot platform.

3. The skateboard roller coaster as described in claim 2 wherein said wheel bearing support are pivotally mounted on wheel bearing blocks, said wheel bearing blocks pivotally attached under the first and second end portions of said foot platform.

4. The skateboard roller coaster as described in claim 3 wherein one of said wheel bearing blocks is pivotally attached to a first pivot bolt attached to the first end portion of said foot platform and another of said wheel bearing blocks is pivotally attached to a second pivot bolt attached to the second end portion of said foot platform.

5. The skateboard roller coaster as described in claim 1 wherein said wheels include upper wheels and lower wheels, said upper wheels engaging a portion of the top of said rail, said lower wheels engaging a portion of the bottom of said rail.

6. The skateboard roller coaster as described in claim 1 wherein said wheels include upper wheels, said upper wheels engaging a portion of the top of said rail.

7. The skateboard roller coaster as described in claim 1 further including an upwardly extending hand grip, said hand grip attached to a side of said foot platform.

8. A human powered skateboard roller coaster used by skateboarders having various degrees of skateboarding skills, the skateboard roller coaster comprising:
a skateboard having a foot platform, said foot platform having a first and a second end portion;
a plurality of wheels mounted on wheel bearings attached to wheel bearing supports, said wheel bearing supports pivotally mounted under the first and second end portion of said foot platform; and
at least one rail forming a roller coaster like track, said roller coaster like track having various curved up and down track configurations, said wheels engaging a portion of said rail for guiding said skateboard thereon.

9. The skateboard roller coaster as described in claim 8 wherein said wheel bearing supports are pivotally mounted on opposite sides of wheel bearing blocks, said wheel bearing blocks pivotally attached under the first and second end portions of said foot platform.

10. The skateboard roller coaster as described in claim 8 wherein one of said wheel bearing blocks is pivotally attached to a first pivot bolt, said first pivot bolt attached to the first end portion of said foot platform, another of said wheel bearing blocks is pivotally attached to a second pivot bolt, said second pivot bolt attached to the second end portion of said foot platform.

11. The skateboard roller coaster as described in claim 8 wherein said wheels include upper wheels and lower wheels, said upper wheels engaging a portion of the top of said rail, said lower wheels engaging a portion of the bottom of said rail.

12. The skateboard roller coaster as described in claim 8 wherein said wheels include upper wheels, said upper wheels engaging a portion of the top of said rail.

13. The skateboard roller coaster as described in claim 8 further including an upwardly extending removable and adjustable hand grip support with a hand grip attached to a top of said hand grip support attached to a side of said foot platform.

14. A human powered skateboard roller coaster used by skateboarders having various degrees of skateboarding skills, the skateboard roller coaster comprising:
a skateboard having a foot platform, said foot platform having a first and a second end portion;
a plurality of wheels mounted on wheel bearings attached to wheel bearing supports, said wheel bearing supports pivotally mounted under the first and second end portion of said foot platform; and
a first rail and a second rail, said first and second rails forming a roller coaster like track, said roller coaster like track having various curved and up and down track configurations, said wheels engaging a portion of said rail for guiding said skateboard thereon.

15. The skateboard roller coaster as described in claim 14 wherein said wheel bearing supports are pivotally mounted on opposite sides of wheel bearing blocks, said wheel bearing blocks pivotally attached under the first and second end portions of said foot platform.

16. The skateboard roller coaster as described in claim 15 wherein one of said wheel bearing blocks is pivotally attached to a first pivot bolt, said first pivot bolt attached to the first end portion of said foot platform, another of said wheel bearing blocks is pivotally attached to a second pivot bolt, said second pivot bolt attached to the second end portion of said foot platform.

17. The skateboard roller coaster as described in claim 14 wherein said wheels include upper wheels and lower wheels, said upper wheels engaging a portion of the top of said first and second rails, said lower wheels engaging a portion of the bottom of said first and second rails.

18. The skateboard roller coaster as described in claim 14 wherein said wheels include upper wheels, said upper wheels engaging a portion of the top of said first and second rails.

19. The skateboard roller coaster as described in claim 14 further including an upwardly extending removable and adjustable hand grip support with a hand grip attached to a top of said hand grip support, said hand grip support attached to a side of said foot platform.
